(19) United States
(12) Patent Application Publication
(10) Pub. No.: US 2006/0006838 A1
(43) Pub. Date: Jan. 12, 2006

(54) Portable tool storage device with power supply unit

(76) Inventor: Michael Clarke, Busingstoke (GB)

Correspondence Address: Kenneth I. Kohn;KOHN & ASSOCIATES, PLLC, Suite 410, 30500 Northwestern Highway, Farmington Hills, MI, 48334, US

(21) Appl. No.: 11/176,788

(22) Filed: Jul. 7, 2005

(30) Foreign Application Priority Data
Jul. 7, 2004 (GB) 0415271.6
Dec. 24, 2004 (GB) 0428387.5

(51) Int. Cl. H02J 7/00

(52) U.S. Cl. 320/114

(57) ABSTRACT

A portable tool storage device 100 having a power supply unit that comprises a rechargeable battery, an electrical connector means 20 by means of which the rechargeable battery can be connected to an external source of electrical power for charging the rechargeable battery, charging circuitry operable to control the charging of said rechargeable battery when the power supply unit is connected to said source of electric power, and a power outlet means 24, 26 electrically connected to the rechargeable battery to permit power to be drawn from the rechargeable battery by an external device.

### CROSS-REFERENCE TO RELATED APPLICATIONS

This application claims priority to Great Britain Serial No. 0415271.6, filed Jul. 7, 2004, which is incorporated herein by reference.

### FIELD OF THE INVENTION

This invention relates to a portable tool storage device with power supply unit.

### BACKGROUND TO THE INVENTION

It used to be the case that electric power tools, such as electric drills, jigsaws and the like, were corded appliances that had to be plugged into the mains for power. Such tools are inconvenient to use if the task being undertaken is some distance from a mains power supply.

While corded power tools are still available (and indeed are preferred for certain applications), advances in battery technology have made it possible to provide cordless power tools into which a rechargeable battery pack (often referred to as a power pack) may be slotted. Black & Decker, amongst others, manufacture and sell a range of cordless power tools that each uses a dedicated power pack, as well as a range of power tools with a common power pack. The Black & Decker HP188F2K (sold under the registered trademark “Firestorm”) is an illustrative example of the former, and the “Cordless Quattro (Registered Trade Mark) Multi-Tool” is an illustrative example of the latter.

The advent of cordless power tools has been generally advantageous as users no longer need to rely on a suitable power source being close to the job in hand. This is particularly advantageous in the construction industry, for example, in circumstances where work is being done on a new building that has not yet been supplied with power.

The power packs of cordless power tools typically provide ample power for the DIY enthusiast who occasionally has one or more relatively small tasks to complete. However, they do not provide enough power for a professional or a regular user, such as a builder, to work for a whole day from only one power pack

To avoid this problem it is not uncommon for professional or regular users to each carry a number of power packs. It is also not uncommon, in circumstances where a number of professional users are working together for example at a building site, for a generator to be hired for the purpose of recharging power packs for the power tools of the professionals working at the site.

Carrying a number of power packs is inconvenient, in the absence of a generator on site, as it requires the user to remember to recharge their power pack or packs at the end of each day. This can be a problem, as users with a number of power packs tend to have only one recharger (principally because spare power packs are sold without rechargers). It is also the case that users tend to recharge all of their power packs (irrespective of whether they are totally without charge), and as is well known it is not recommended (for maximizing power pack life) to recharge power packs that are only partly discharged.

The hire of a generator is undesirable as this can be relatively expensive. Use of a generator also has health and safety implications, and may even not be feasible if the site is one where fumes or noise from a generator might cause problems.

### STATEMENT OF INVENTION

The invention provides a portable tool storage device having a power supply unit that comprises a rechargeable battery means, an electrical connector means by means of which the rechargeable battery means can be connected to an external source of electrical power for charging the rechargeable battery means, a power outlet means electrically connected to the rechargeable battery means to permit power to be drawn from the rechargeable battery means by an external device and a DC to AC conversion means connected between the rechargeable battery means and the power outlet means, the DC to AC conversion means being operable to convert DC power from the rechargeable battery means to AC power for the power outlet means.

### BRIEF DESCRIPTION OF THE DRAWINGS

Embodiments of the invention, which are given by way of example only, will now be described, with reference to the accompanying drawings, in which:

FIG. 1 is a schematic illustration of the components of a portable power supply unit;

FIG. 2 is a perspective view of a toolbox incorporating the portable power supply unit of FIG. 1;

FIG. 3 is a perspective view of another toolbox incorporating the portable power supply unit of FIG. 1; and

FIG. 4 is a perspective view of yet another toolbox incorporating the portable power supply unit of FIG. 1.

### DETAILED DESCRIPTION OF PREFERRED EMBODIMENTS

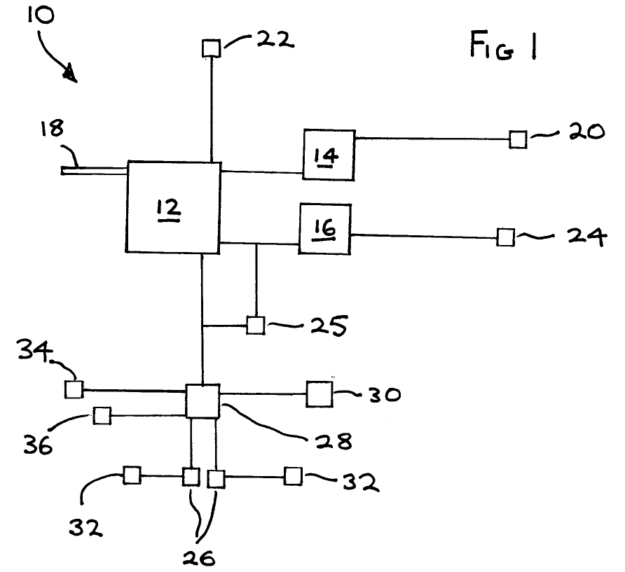

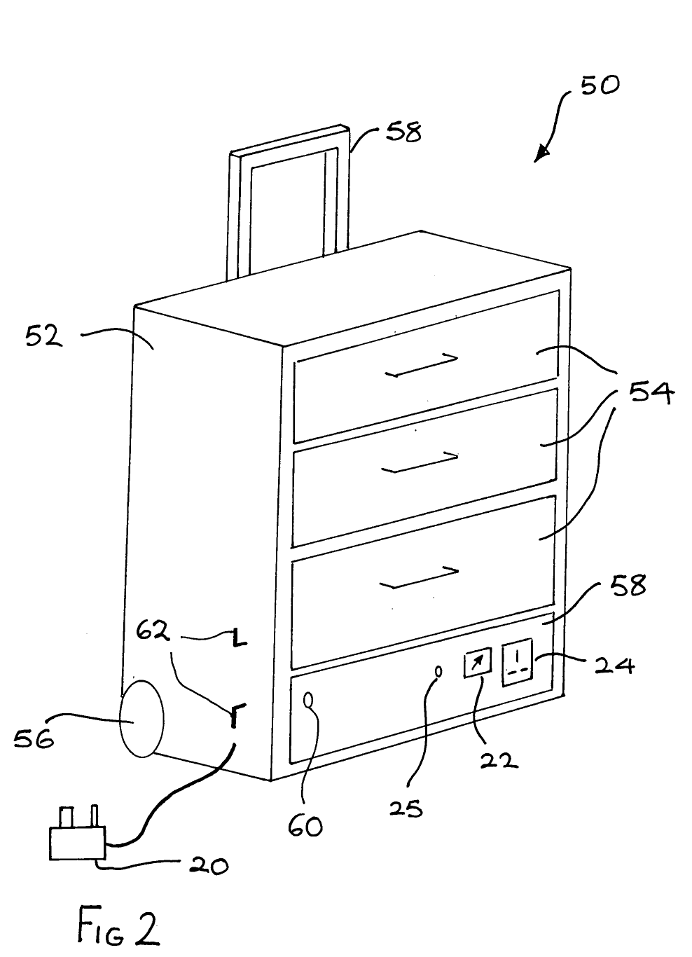

FIG. 1 is a schematic representation (not a circuit diagram) of the components of a portable power supply unit 10 for incorporation in a tool storage device, such as the tool boxes shown in FIGS. 2, 3 and 4.

The portable power supply 10 comprises a rechargeable battery 12 that is coupled to a battery charger 14 and a DC to AC converter 16.

The rechargeable battery 12 is a deep discharge lead/acid battery with the electrolyte in the form of a gel. However, in principle, any type of rechargeable battery may be used. For example, the battery could comprise a heavy-duty nickel cadmium (NiCad) battery. The rechargeable battery could also comprise a number of batteries connected together to form a battery array (it being understood that the generic term “battery” extends in scope to cover an array of individual batteries as well as the individual battery).

The battery 12 is coupled to a vent pipe 18, which, as described below, is used to vent any gases or liquids generated by the battery to atmosphere. In the case of a car battery it is anticipated that about 750 watts hours of power could be provided (which is enough to charge several power packs, or even to power tools directly).

The battery charger 14 is electrically connected to a plug 20 (for example a 13 amp three-pin plug) by way of a suitable electric cable. The plug 20 can be plugged into a socket (not shown) of a mains power supply to recharge the rechargeable battery 12.

The battery charger 14 controls the charging of the battery, for example to ensure that the battery is not overcharged. A charge indicator 22 is connected across the terminals of the rechargeable battery 22 to give users a visual indication of the battery condition. Any suitable battery charger may be used and, since many different types of battery recharger will be known to those skilled in the art, a detailed description of the operation of such devices 2 will not be provided herein.

The unit 10 is provided with a reset button 25, which functions as a current limit switch and is configured to pop out and open a switch inside the unit to disconnect the battery 12 in the event that the battery current exceeds a given limit (as might happen were the battery to be short-circuited or if any of the components of the unit should suffer a catastrophic failure). Once the battery 12 has been charged or recharged, power stored in the battery can be used to recharge power packs for cordless power tools.

The recharging of cordless power packs may be accomplished by plugging a power pack recharger (commonly sold with the cordless power tool in question) into a three-pin socket 24 that is electrically connected to the DC to AC converter 16 by means of suitable electric cabling. The DC to AC converter 16 converts direct current from the battery 12 into alternating current for supply to the power pack recharger.

This arrangement is particularly advantageous as power pack rechargers tend to be designed for use with the particular type of power pack with which they are sold. For commercial and safety reasons power packs and their associated rechargers also tend to be designed so that only a power pack for use with a particular charger can be mechanically fitted to that charger.

Providing the portable power supply unit 10 with a three pin socket 24 as a power outlet, allows the dedicated power pack recharger for any power pack to be connected to the battery 1 so that the portable supply unit is not limited to its application. A further advantage of this arrangement is that the portable supply unit does not need to be provided with control circuitry required to control the recharging of power packs (that circuitry being provided in the rechargers that can be plugged into the unit). This makes manufacture cheaper and increases the flexibility of the unit. Another advantage of this arrangement is that the power supply unit 10 may be used to directly power corded power tools, or indeed other equipment requiring an AC supply.

As an alternative, or in addition to, the provision of the three-pin socket 24, the portable power unit 10 may be provided with one or more power pack sockets 26 into which compatible power packs may be plugged. In this case, it would be necessary to provide suitable conditioning circuitry 28 between the battery 12 and the power pack socket(s) 26. The conditioning circuitry 28 would typically include a DC to AC converter.

If two sockets 26 are provided they could be of the same design or different designs (to accommodate two power packs of the same type or two different types of power pack respectively).

The power pack socket(s) 26 and conditioning circuitry 28 may be designed only to accept and recharge one type of power pack, or in a highly preferred arrangement the conditioning circuitry 28 may be operable to detect the type of power pack plugged into the socket(s) 26, and control the recharging of that power pack accordingly. Circuitry providing this functionality is well known in the art and so will not be described in detail herein.

The power pack socket(s) 26 could be designed to accommodate power packs from different manufacturers, which are all of roughly the same physical shape. For example, a universal power pack socket could readily be fashioned to accommodate power packs sold by Dewalt, Ryobi, Hitachi and Bosch as all of these power packs have a similar shape.

As an alternative to, or more preferably in addition to, providing conditioning circuitry 28 that is operable to detect the type of power pack plugged into the socket(s) 26, a user operable switch 30 may be provided to enable the user to select different settings for different power pack types. If such a switch 30 is provided, it is preferable that the conditioning circuitry 28 is configured to override a user selected setting in the event the user inadvertently sets the switch to an incorrect setting for the particular power pack or packs plugged into the unit. The unit could alternatively be arranged to prevent recharging of a power pack in the event of mismatch between the power pack selected at the switch 30 and the power pack is detected by the unit and provide the user with a warning that this has occurred, for example by means of a warning light or sound.

The unit 10 may be provided with means 82 to display to the user an indication of the state (such as the amount of power stored) of one or more power packs plugged into it. The unit 10 may be provided with means to calculate an indication of the state of repair of a given power pack by determining, for example, the ratio between the maximum theoretical charge that the pack could accept and the charge that the pack will actually accept, and thereby provide the user with an early indication of a possible power pack failure.

This functionality might be provided, for example, by providing a capacity indicator 34, which is coupled to the conditioning circuitry 28, and a selector switch 36, which can be toggled by a user to cause the display on the capacity indicator 34 of an indication of the power stored in the battery 12, or the state of the or each power pack plugged into the unit. It will be appreciated that where the capacity indicator 34 is provided, the indicators 22 and 32 may be dispensed with.

The portable power supply unit 10 has been described as incorporating many different components, some of which are duplicative. This is simply for ease of description and illustration of the features that can be incorporated into the unit. For example, in a unit having an outlet in the form of a socket 23 and one, or more, power pack sockets 26, two separate DC to AC converters have been described. However, in practice, it would only be necessary to provide one such converter. However, since the skilled person will readily be able to devise the most suitable circuitry to implement the possibilities illustrated by FIG. 1, a detailed description of such circuitry will not be provided.

FIG. 2 shows a toolbox 50 incorporating the portable power supply unit 10. The toolbox comprises a housing 52 fitted with three drawers 54. The housing 52 is provided with a pair of rear mounted wheels 56, and a handle 58 so that the toolbox can easily be wheeled from one location to another.

The power supply unit 10 may be built into one of the drawers 54 so that it can be removed for maintenance. Alternatively it may be built into the housing so that a user cannot normally gain access to the components of the power supply unit. In the embodiment shown in FIG. 2, the power supply unit 10 is built into the housing 52 beneath the lowermost drawer 54. The outlet socket 24 of the unit 10 is mounted in a facia panel 58 of the toolbox alongside the indicator 22. A vent hole 60 is connected to the vent pipe 18. The plug 20 and cabling extends from a side of the housing 52. When not in use, the cabling can be wound round a pair of brackets 62 provided on the side of housing 52.

In this embodiment, the power supply unit 10 does not include power pack sockets 26 or the associated conditioning circuitry. The tool box 50 is intended to enable the recharging of power packs via a recharging device powered via the socket 24. Alternatively, power tools, and other devices requiring an AC supply can be powered directly from the power supply unit 10.

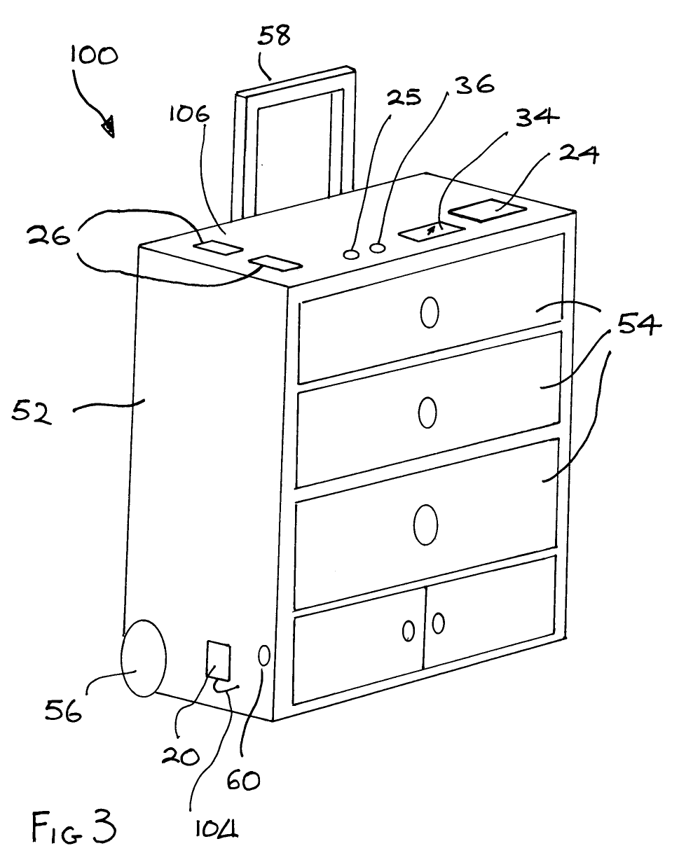

FIG. 3 shows another toolbox 100 incorporating a portable power supply 10 as shown in FIG. 1. The toolbox 100 is similar to the toolbox 50 and so, to avoid unnecessary repetition of the description, like parts are referenced by the same reference numeral.

In this embodiment, the battery 12 and other larger components, such as the battery charger 14 and the DC to AC converter 16 are mounted in the bottom part of the toolbox. The parts of unit mounted in the bottom of the toolbox are preferably accessible via doors 102 and may be mounted on a tray that can slide out of the toolbox on telescopic rails to improve accessibility. Alternatively, the parts of the unit 10 mounted in the bottom of the toolbox may be fitted in a drawer fitted in place of the doors 102.

The plug 20 is shown fitted in a dummy three-pin socket provided in the side of the housing 52. This allows the plug to be stored neatly when not in use. The cable 104 for the plug 20 is spooled on a spring-loaded winding drum housed in the toolbox 100 so that when not in use, it is stored in the toolbox.

In this embodiment, the three-pin socket 24, reset button 25, power pack sockets 26, battery capacity indicator 34 and selector switch 36 are all provided in a top panel 106 of the housing 52. Users may find this location more convenient than the arrangement shown in FIG. 2. Furthermore, it is preferable not to have battery packs protruding from side panels of the housing while they are being charged.

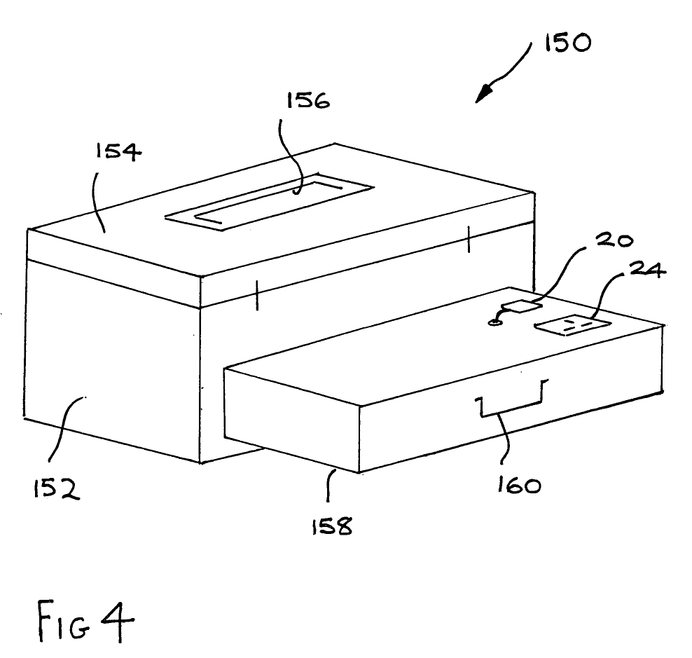

FIG. 4 shows an alternative embodiment in which the toolbox 150 is designed to be carried rather than wheeled. The battery 12 enclosed within the toolbox 150 may be smaller than that enclosed within the wheeled version so as to reduce the overall weight of the toolbox.

The toolbox 150 comprises a casing 152 with a lid 154 mounted to its upper edge by hinges (not shown). The lid 154 has a carry handle 156 mounted on its top face. A drawer 158 is provided in the bottom portion of the casing 152 and has a handle 160 so that it can be pulled out of the casing to reveal the socket 24 of a portable power supply unit 10 housed in the drawer. Also shown is a plug 20 and flex, which can be used to plug the power supply unit 10 into the mains for recharging the battery 12. The plug 20 is shown in a stored, non-use, position in the same way as the plug 20 shown in FIG. 3. The upper portion of the casing 152 defines a trough above the drawer cavity in which tools can be stored.

It will be apparent in light of the foregoing that the embodiments described herein provide a toolbox fitted with a portable power supply unit that is convenient to use, relatively inexpensive to construct. Another advantage of at least some of the embodiments described is that the power supply unit is readily transportable and this means that it could be carried up a ladder by someone working on a roof or indeed carried into a relatively inaccessible workplace, such as a mineshaft. Clearly, it would be wholly impractical to consider using a generator in such circumstances.

It will be understood that while certain preferred embodiments have been described, the scope of the invention is not limited to those embodiments, but instead encompasses all modifications and embodiments that fall within the scope of the claims. For example, the described embodiments utilize a three-pin socket 7, it will be apparent that any other type of electrical connector (such as a two pin socket) could be used instead. It will also be apparent that the voltage output of the unit may be varied as required. For example, the unit could output V AC, or be designed to output 115 V AC—the latter being commonly used on building sites.

It will be appreciated that the rechargeable battery 12 could be replaced by any other type of rechargeable power storage device—such as a hydrogen fuel cell for example.

As an alternative to the plug 20 and battery charger 14, the portable power supply unit 10 may be provided with an inlet socket connected directly to the rechargeable battery means. This socket would allow connection to an external battery charger. Alternatively, or in addition, the inlet socket would allow the rechargeable battery means to be electrically connected to the “cigar lighter” socket of a vehicle so that recharging could take place in a vehicle, for example, during a journey to, or from, a work site. The inlet socket would preferably be of the “cigar lighter” type. The unit 10 could be provided with both the battery charger 14 and plug 20 and a cigar lighter type inlet socket. An advantage of not having the battery charger 14 is that it makes the tool box lighter.

It will be appreciated that the various features of the portable power unit 10 described may be variously incorporated in the tool storage devices shown and the invention is not limited to the specific configurations shown.

It will be understood that the portable power supply unit can readily be constructed such that it complies with any given working place requirements. For example, the unit may be constructed to comply with IP65 dust and water ingress requirements, or to meet the ATEX explosive atmospheres directive.

1. A portable tool storage device having a power supply unit that comprises a rechargeable battery means, an electrical connector means by means of which the rechargeable battery means can be connected to an external source of electrical power for charging the rechargeable battery means, a power outlet means electrically connected to the rechargeable battery means to permit power to be drawn from the rechargeable battery means by an external device and a DC to AC conversion means connected between the rechargeable battery means and the power outlet means, the DC to AC conversion means being operable to convert DC power from the rechargeable battery means to AC power for the power outlet means.

2. A device as claimed in claim 1, further comprising charging circuit means connected between said electrical connector means and the rechargeable battery means, said charging circuit means controlling charging of the rechargeable battery means.

3. A device as claimed in claim 1, wherein the power outlet means comprises a three pin electrical socket.

4. A device as claimed in claim 1, wherein the power outlet means comprises at least one power pack socket into which a power pack of a cordless power tool may be plugged.

5. A device as claimed in claim 4, wherein the power supply unit further comprises conditioning circuitry to control the charging of a power pack plugged into the or each said power pack socket.

6. A device as claimed in claim 4, wherein a said power pack socket comprises a universal socket into which differently shaped power packs can be plugged.

7. A device as claimed in any one of the preceding claims, wherein the power supply unit comprises a capacity indicator operable to indicate the power stored in said rechargeable battery means.

8. A device as claimed in claim 7, wherein said capacity indicator is connected across the terminals of said battery.

9. A device as claimed in claim 7, when dependent on claim 5, wherein the capacity indicator is connected to the conditioning circuitry and is operable to provide a visual indication of the power stored in the rechargeable battery means as determined by said conditioning circuitry.

10. A device as claimed in claim 9, wherein the power supply unit further comprises a user operable selector switch coupled to said conditioning circuitry and operable to control the conditioning circuitry such that said capacity indicator displays information relating to a power pack lugged into the or one of said power pack sockets.

11. A device as claimed in claim 10, wherein said information comprises an indication of the power stored in said power pack.

12. A device as claimed in claim 10, wherein said information comprises an indication of the condition of a said power pack.

13. A device as claimed in claim 1, wherein the electrical connector means includes electric cabling spooled on a rewind drum within the tool storage device.

14. A device as claimed in claim 1, wherein said electrical connector means comprises a plug and the device further comprises a dummy socket for said plug into which the plug can be plugged when not in use.

15. A device as claimed in claim 1, wherein said rechargeable battery means comprises a lead/acid battery.

16. A device as claimed in claim 1, wherein said rechargeable battery means comprises a nickel cadmium (NiCad) battery.

17. A device as claimed in claim 1, further comprising second power outlet means electrically connected to the rechargeable battery means to permit power to be drawn from the rechargeable battery means, said second power outlet means providing a DC power supply.

18. A device as claimed in claim 1, wherein said power supply unit is built into a drawer of the device.

19. A device according to claim 1, provided with wheels.

20. A portable tool storage device substantially as hereinbefore described with reference to the drawings.
